(19) United States
(12) Patent Application Publication
(10) Pub. No.: US 2015/0006339 A1
(43) Pub. Date: Jan. 1, 2015

(54) APPLICATION FOR PAYROLL PROVIDERS

(71) Applicant: Bank of America Corporation, Charlotte, NC (US)

(72) Inventors: Jennifer M. Lucas, Charlotte, NC (US); Jason M. Martin, Charlotte, NC (US)

(21) Appl. No.: 13/932,410

(22) Filed: Jul. 1, 2013

(51) Int. Cl. G06Q 40/00

(52) U.S. Cl. CPC G06Q 40/12
USPC 705/30

(57) ABSTRACT

Embodiments of the invention are directed to systems, methods and computer program products for enrolling in a direct deposit program. In some embodiments, a system is configured to: initiate the presentation of a first interface prompting a user to enter user credentials associated with the user's financial institution account for registration of the user's payroll information; retrieve information associated with the user's financial institution account based on a successful verification of the user credentials, wherein the information includes an account number and a transit routing number; initiate the presentation of a second interface, wherein the second interface is populated with the retrieved information; and complete the registration of the user's payroll information based on user confirmation of the retrieved information.

### BACKGROUND

There is a need to enable quick and efficient enrollment into a direct deposit program.

### BRIEF SUMMARY

In some embodiments, an apparatus for enrolling in a direct deposit program is provided. The apparatus comprises a memory, a processor, and a module stored in memory, executable by the processor, and configured to: initiate the presentation of a first interface prompting a user to enter user credentials associated with the user's financial institution account for registration of the user's payroll information; retrieve information associated with the user's financial institution account based on a successful verification of the user credentials, wherein the information includes an account number and a transit routing number; initiate the presentation of a second interface, wherein the second interface is populated with the retrieved information; and complete the registration of the user's payroll information based on user confirmation of the retrieved information.

In some embodiments, the user credentials comprise at least one of a username, a password, a passcode, or an answer to a security question.

In some embodiments, the verification of the user credentials includes matching the user credentials entered by the user with user credentials stored in a database.

In some embodiments, the user's financial account comprises a checking account, a savings account, or an investment account.

In some embodiments, the second interface prompts the user to select at least one financial institution account.

In some embodiments, the second interface prompts the user to select at least two financial institution accounts, wherein the two financial institution accounts are associated with different financial institutions.

In some embodiments, the second interface prompts the user to select at least two financial institution accounts, wherein the two financial institution accounts are associated with the same financial institution.

In some embodiments, the retrieved information is associated with the user selection of at least one financial institution account.

In some embodiments, the user's selection of the financial institution account is modifiable.

In some embodiments, the retrieved information is used to set up a direct deposit.

In some embodiments, the user selection of a first account is associated with a first direct deposit percentage amount and the user selection of a second account is associated with a second direct deposit percentage amount.

In some embodiments, the first account and the second account are sequentially sorted based on at least the first direct deposit percentage amount and the second direct deposit percentage amount.

In some embodiments, the user selection of a first account is associated with a first direct deposit amount and the user selection of a second account is associated with a second direct deposit amount.

In some embodiments, the user selection the first account and second account are sequentially sorted based on at least the first direct deposit amount and the second direct deposit amount.

In some embodiments, the second interface displays a remaining balance associated with the direct deposit amount.

In some embodiments, populating the retrieved information includes initiating a presentation of a third interface to the user to receive user confirmation of the retrieved information.

In some embodiments, the second interface displays a summary of the retrieved information.

In some embodiments, the population of the retrieved information occurs substantially simultaneously to successfully verifying the user credentials.

In some embodiments, a method for enrolling in a direct deposit program is provided. The method comprises: initiating the presentation of a first interface prompting the user to enter user credentials associated with the user's financial institution account for registration of the user's payroll information; retrieving information associated with the user's financial institution account based on a successful verification of the user credentials, wherein the information includes an account number and a transit routing number initiating the presentation of a second interface, wherein the second interface is populated with the retrieved information; and completing the registration of the user's payroll information based on user confirmation of the retrieved information.

In some embodiments, a computer program product for enrolling in a direct deposit program is provided. The computer program product comprises a non-transitory computer-readable medium comprising code causing a computer to: initiate the presentation of a first interface prompting a user to enter user credentials associated with the user's financial institution account for registration of the user's payroll information; retrieve information associated with the user's financial institution account based on a successful verification of the user credentials, wherein the information includes an account number and a transit routing number; initiate the presentation of a second interface, wherein the second interface is populated with the retrieved information; and complete the registration of the user's payroll information based on user confirmation of the retrieved information.

### BRIEF DESCRIPTION OF THE DRAWINGS

Having thus described embodiments of the invention in general terms, reference will now be made to the accompanying drawings, where:

FIG. 1 is a general process flow for enrolling in a direct deposit program;

FIG. 2 is an exemplary user interface for a payroll summary, in accordance with embodiments of the present invention;

FIG. 3 is an exemplary user interface for editing direct deposit information, in accordance with embodiments of the present invention;

FIG. 4 is an exemplary user interface for signing into online banking, in accordance with embodiments of the present invention;

FIG. 5 is an exemplary user interface for authenticating entry into online banking, in accordance with embodiments of the present invention;

FIG. 6 is an exemplary user interface for a wait message, in accordance with embodiments of the present invention;

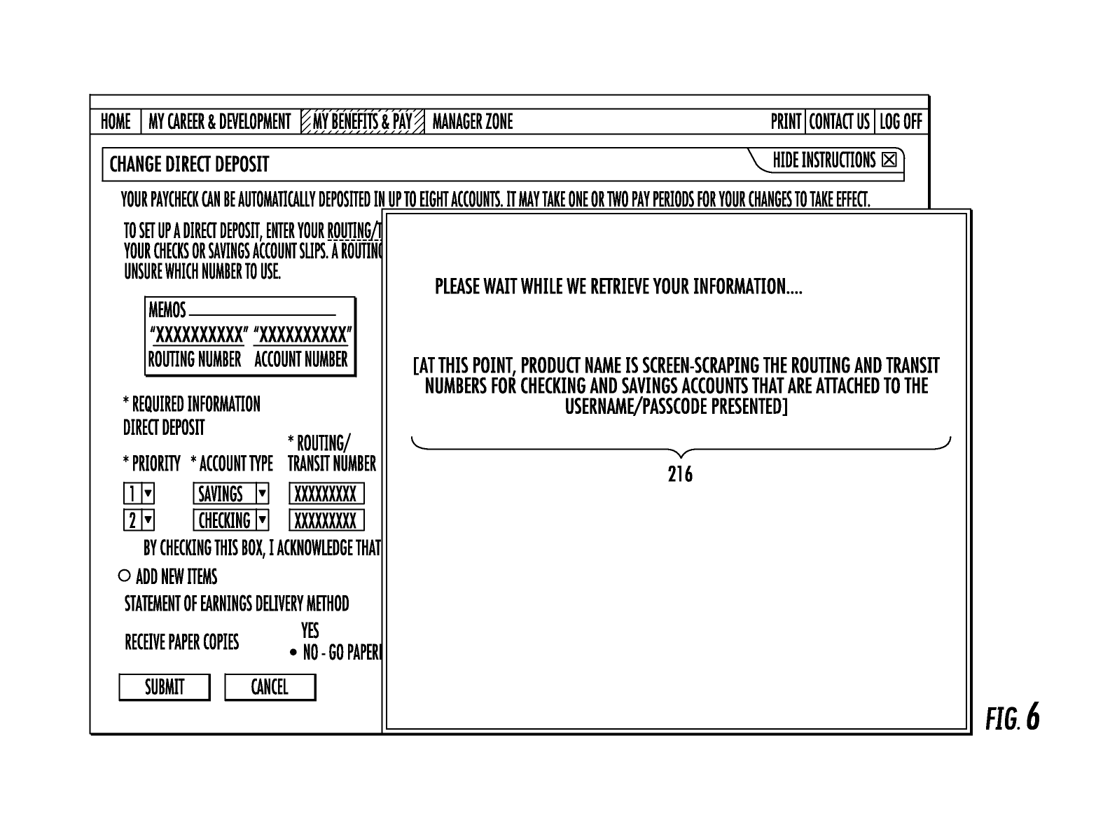

FIG. 7 is an exemplary user interface for selecting a bank account, in accordance with embodiments of the present invention;

FIG. 8 is an exemplary user interface for prefilling account information, in accordance with embodiments of the present invention; and

FIG. 9 is an exemplary system diagram for executing the present invention, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g. a banking account), a savings account, an investment account, a money market account, a time deposit, a demand deposit, a pre-paid account, a credit account, a non-monetary user profile that includes only personal information associated with the user, or the like. The account is associated with and/or maintained by an entity. In other embodiments, an “entity” may not be a financial institution.

In some embodiments, a “user” may be a customer (e.g. an account holder or a person who has an account (e.g. banking account, credit account, or the like) at the entity), a merchant (e.g. a business, a vendor, a service provider, or the like), or an employee of a business. The user may also be an agent (customer service representative, internal operations specialist, bank teller, account manager, IT technician, database manager, mainframe operator, or the like) associated with the entity who is responsible for payroll operations.

The present invention may enable an apparatus (e.g. a computer system) associated with the entity to efficiently enroll the user into a direct deposit program for payroll purposes. The benefit of the direct deposit program may be that the user saves time by automatically depositing his or her paycheck without having to go to a banking location or an automatic teller machine (ATM). Uniquely, the present invention utilizes secure aggregation methods, such as screen scraping, to automatically collect information associated with the user's bank account(s) and prefill the direct deposit enrollment forms. Specifically, the present invention may be used for the purpose of obtaining the direct deposit account number and automatically importing it into a payroll system. This enables the user to quickly enroll into the direct deposit program without having to manually search for a check, a routing number, a transit number, an account number, or the like. Furthermore, the entity may benefit from the automated enrollment process because its ease of enrollment into the direct deposit program may potentially increase direct deposit penetration throughout the entity's customer segments.

In some embodiments, the present invention may be integrated with an online payroll system associated with the entity, an employer, a company, a third party payroll provider, or the like. The user may have an account with any bank or financial institution so long as they permit the aggregation of account information. The application may enable the user to log in to the payroll system and from there the user may enroll into the direct deposit program.

After the user logs into the payroll system, he may select the bank with which his account is associated. In some embodiments, the bank may be the entity. In other embodiments, the apparatus may be configured to support multiple banks or multiple accounts associated with the user. Once the user selects his bank, he may be required to provide authentication associated with the bank. For example, the user may be required to provide a password, a passcode, a user identification number, an answer to a security question, or the like. The apparatus may automatically verify the security measures with the selected bank to enable the user to access his account or information associated with his account.

Upon positive verification of the user's relationship with the selected bank, the apparatus may automatically retrieve information associated with the user's account. In some embodiments, the apparatus may utilize secure industry aggregation methods, such as screen scraping, to locate and obtain the requested information. Typically, the apparatus retrieves information associated with the user's account so he may enroll in the direct deposit program. The retrieved information (an account number, a routing number, a transmit number, a check number, a date, an amount, a bank's contact information, or the like) may be stored in a database (or in a datastore, on a server, or the like) and may be recalled for later use.

The apparatus may present the retrieved account information to the user via an interface that enables the user to select into which account he directly deposits his pay. In some embodiments, the user may select one account. In other embodiments, the user may select multiple accounts. In alternative embodiments, the user may select different types of accounts including a checking account, a savings account, an investment account, or the like. The apparatus may also use the retrieved information to display one or more field of information associated with the account(s). Fields of information may include an account type, an account number, a routing number, a transit number, or the like.

After the user selects the account(s) into which he directly deposits, the apparatus may present to the user an interface that summarizes the direct deposit enrollment. Information associated with the selected account(s) may include a priority level, an account type, a routing number, a transit number, an account number, a financial institution, an amount, a percent, a remaining balance, or the like and may be prefilled by the apparatus. The user may select how much of his paycheck is to be directly deposited into each selected account. For example, the user may wish to directly deposit ten percent of his paycheck into a savings account while directly depositing the remaining ninety percent into a checking account. The user may allocate his paycheck using a numerical dollar amount, a percent of the paycheck, a remaining balance, or the like. Furthermore, the user may change, edit, add, or delete the allocation of funds into each account at any time.

To continue, the user may review the prefilled information associated with the selected direct deposit accounts. In some embodiments, the user may be required to verify that the prefilled information is indeed correct. In other embodiments, the user may be required to verify that he agrees to the terms and conditions of the direct deposit program. Upon positive verification, the user may submit the form. The apparatus may import the enrollment form into the direct deposit program and the direct deposit may take effect for the next payroll cycle.

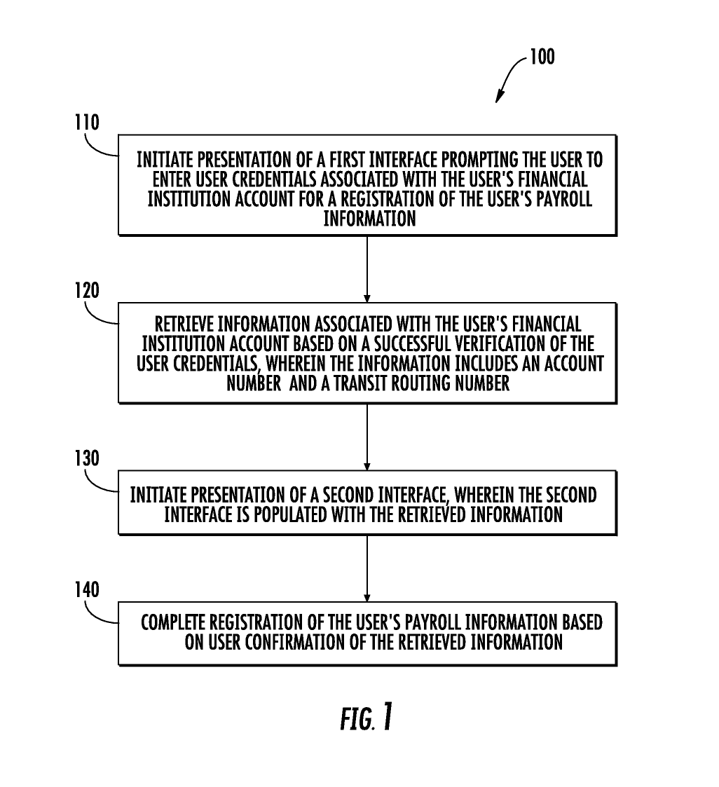

FIG. 1 illustrates an exemplary process flow 100 for enrolling in a direct deposit program. At block 110, the process includes initiating the presentation of a first interface prompting the user to enter user credentials associated with the user's financial institution account for a registration of the user's payroll information. At block 120, the process includes retrieving information associated with the user's financial institution account based on a successful verification of the user credentials, wherein the information includes an account number and a transit routing number. At block 130, the process includes initiating the presentation of a second interface, wherein the second interface is populated with the retrieved information. At block 140, the process includes completing the registration of the user's payroll information based on user confirmation of the retrieved information.

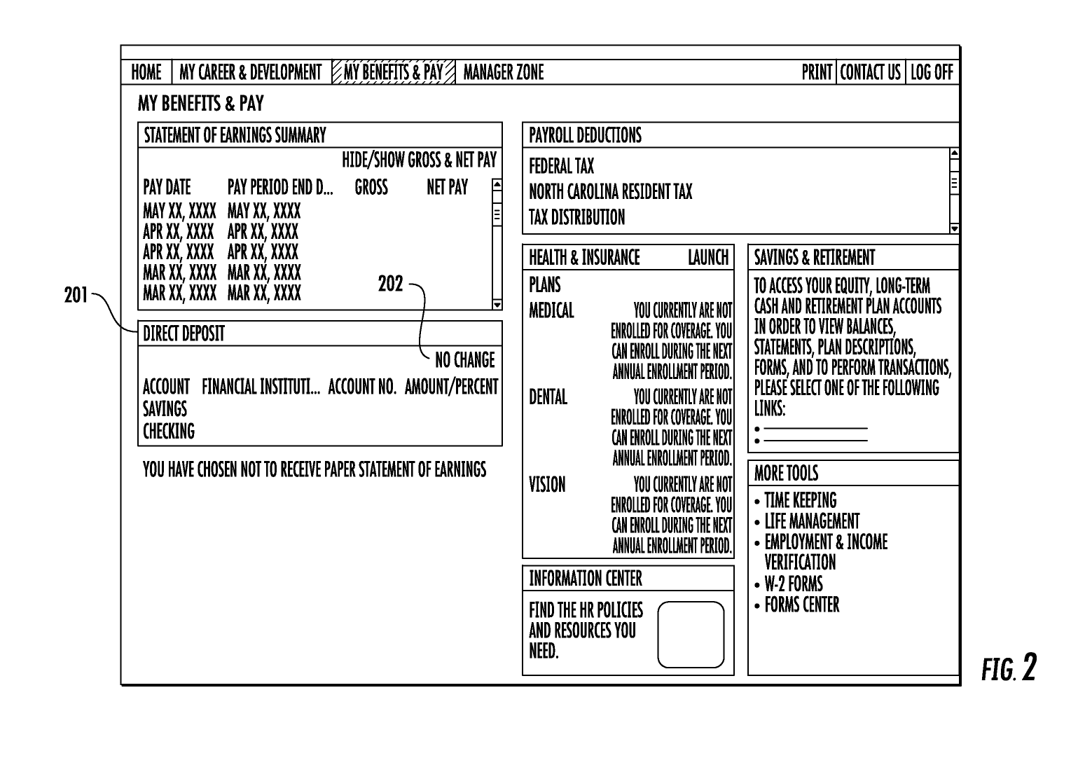

FIG. 2 illustrates an exemplary user interface for a payroll summary. The exemplary user interface in FIG. 2 may be presented to the user once the user has logged into his or her payroll provider's portal. The payroll summary may include benefits and pay and a summary of earnings, payroll deductions, or the like. Furthermore, a summary of direct deposit activity 201 may be presented to the user. By selecting the Change 202 button, the user may manage how his paycheck is directly deposited into one or more of his accounts.

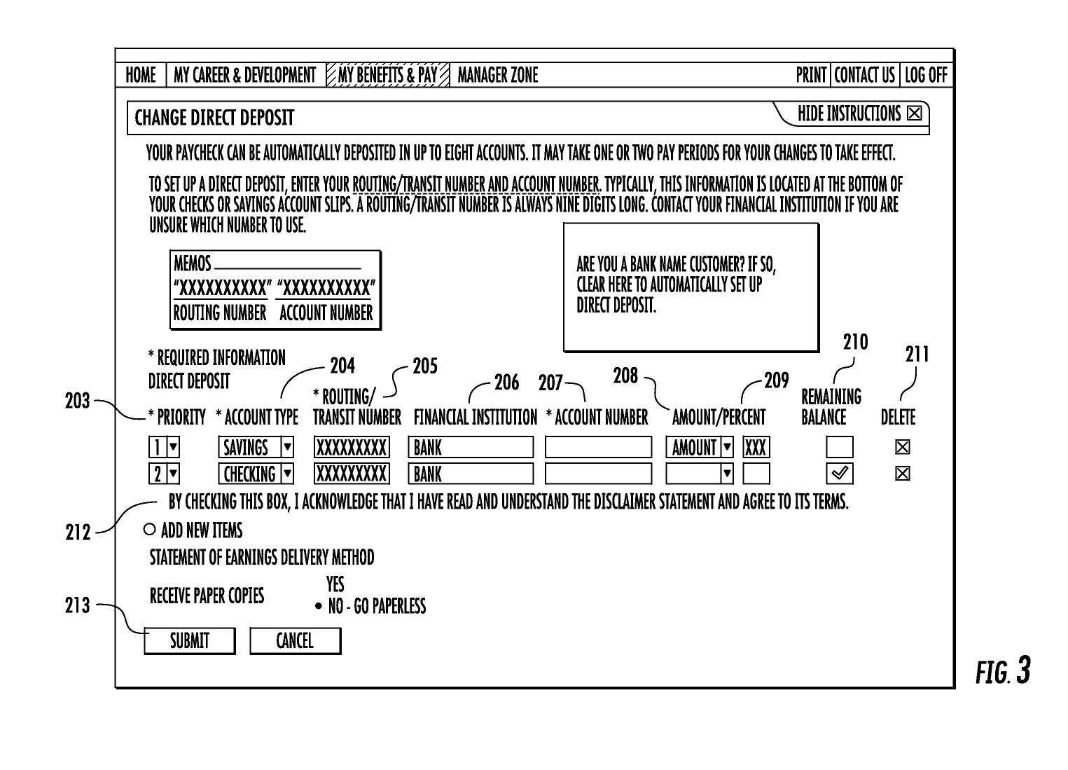

After the user selects the Change 202 button, the apparatus may present to the user an exemplary user interface for editing direct deposit information as shown in FIG. 3. The user may view a summary of his accounts that are configured to accept direct deposit payments. Items in the summary view may include a priority 203 associated with each account, an account type 204, a routing or transit number 205, a financial institution name 206, an account number 207, an amount of the paycheck allocated to each account 208, a percentage of the paycheck amount allocated to each account 209, an option to allocate the remaining balance of a paycheck to each account 210, or a Delete 211 button. The user may agree 212 to terms and conditions associated with enrolling in the direct deposit program. The interface may also include instructions for how to enroll into the direct deposit program, how to edit information associated with the user's accounts, or the like. The user may also select to automatically enroll in the direct deposit program. The user may select the Submit 213 button to submit his information into the direct deposit program.

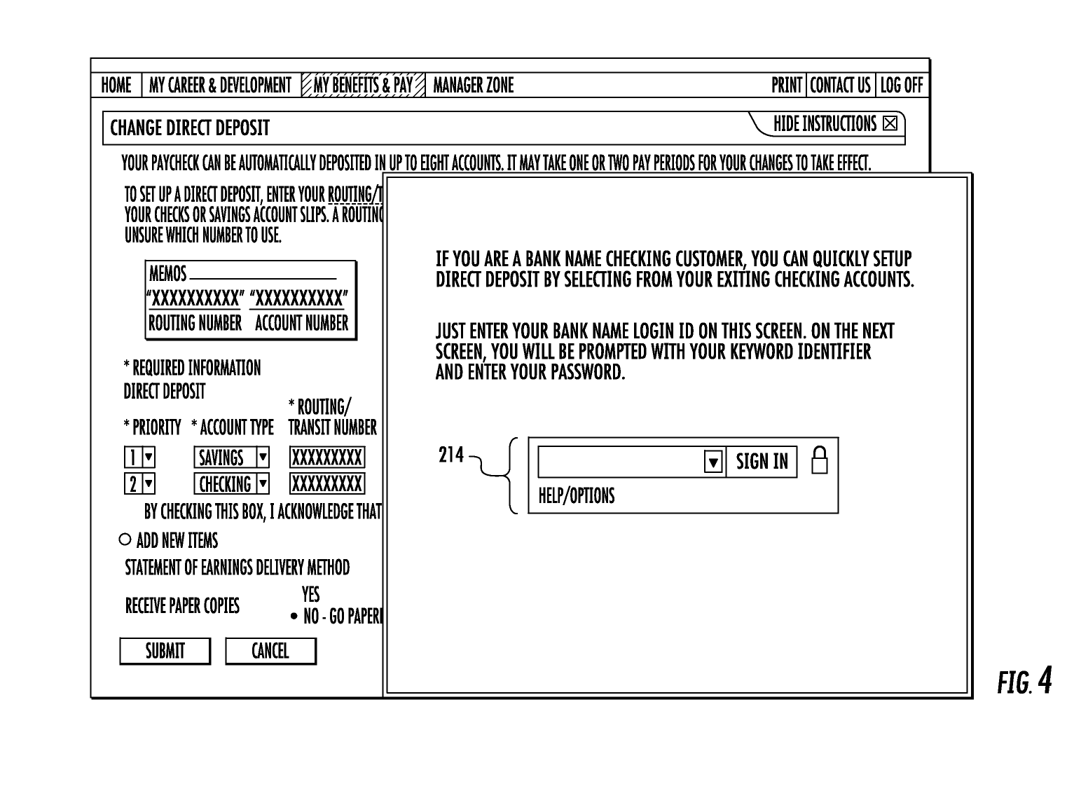

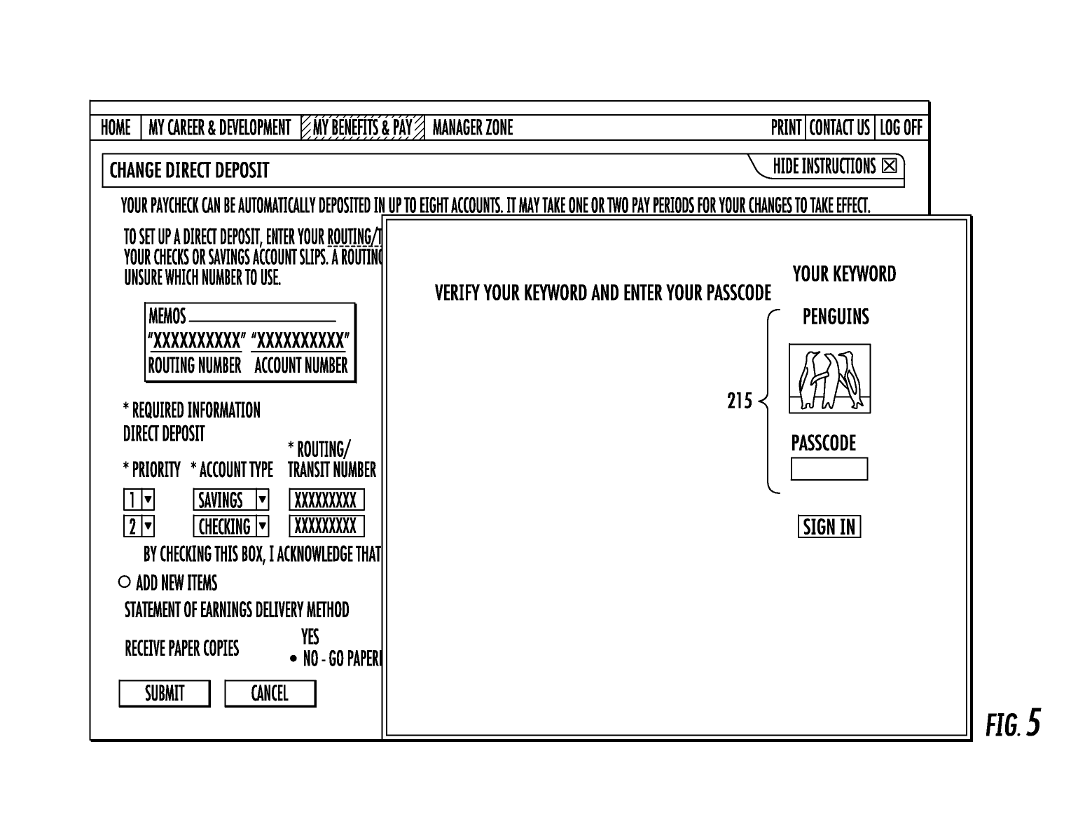

If the user wishes to automatically enroll in the direct deposit program, he may be prompted by the apparatus to sign into online banking account as illustrated in FIG. 4. By entering in his online banking username 214, the user may begin the automatic enrollment process. The user may also be prompted by the apparatus to enter authentication 215 associated with his online banking account. For example, as seen in FIG. 5, the user may be required to input a password, a passcode, or the like.

Upon successful entry of the user's online banking credentials, the apparatus may present to the user a wait message 216 as it retrieves the user's account information. The apparatus may automatically retrieve the user's information associated with his financial entity. For example, the apparatus may automatically retrieve the user's transit or routing number, an account number, or the like for one or more of the user's accounts. In some embodiments, the apparatus may collect information associated with multiple accounts or account types, such as a checking account and savings account.

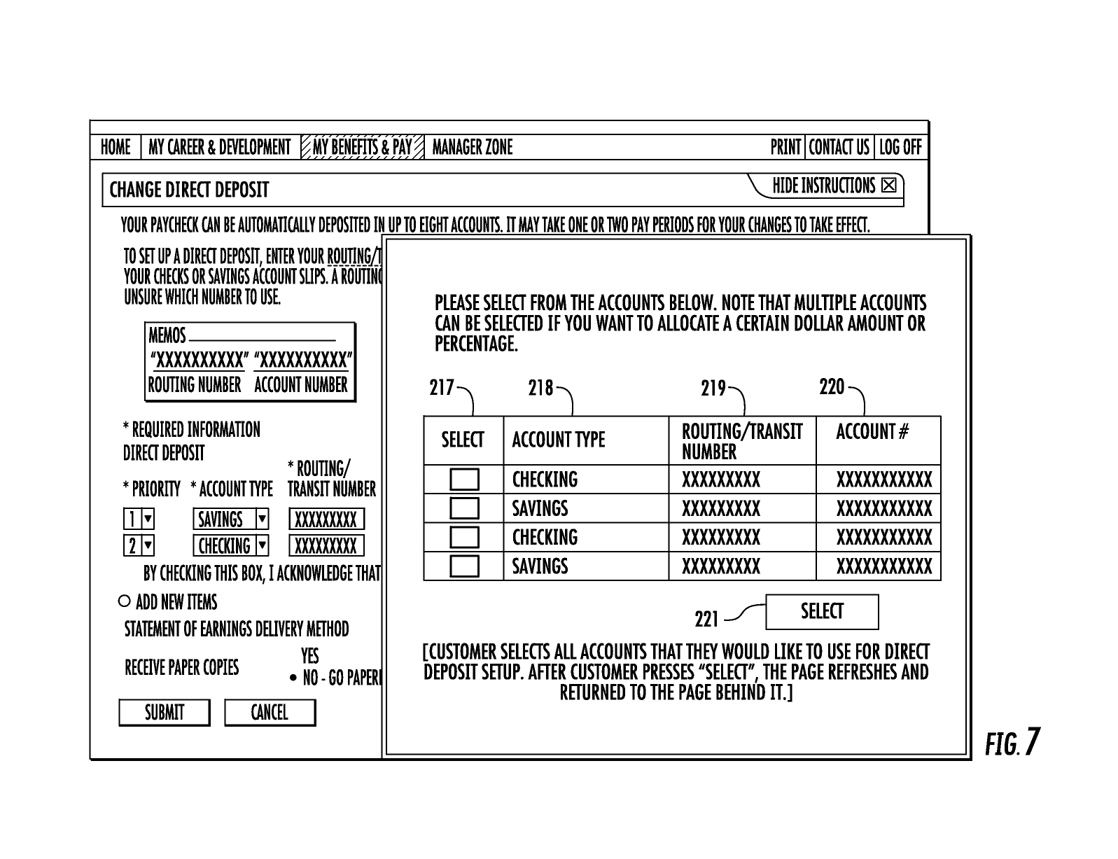

Once the apparatus has automatically retrieved the information associated with one or more of the user's accounts, the apparatus may present to the user an overview or summary of the collected information, as depicted in FIG. 7. The user may select via the Select 217 button which account to enroll in the direct deposit program as well as review the account type 218, the routing/transit number 219, and the account number 220 of each account. In some embodiments, the user may select one account. In other embodiments, the user may select multiple accounts. The Select 221 button confirms the user's account choices.

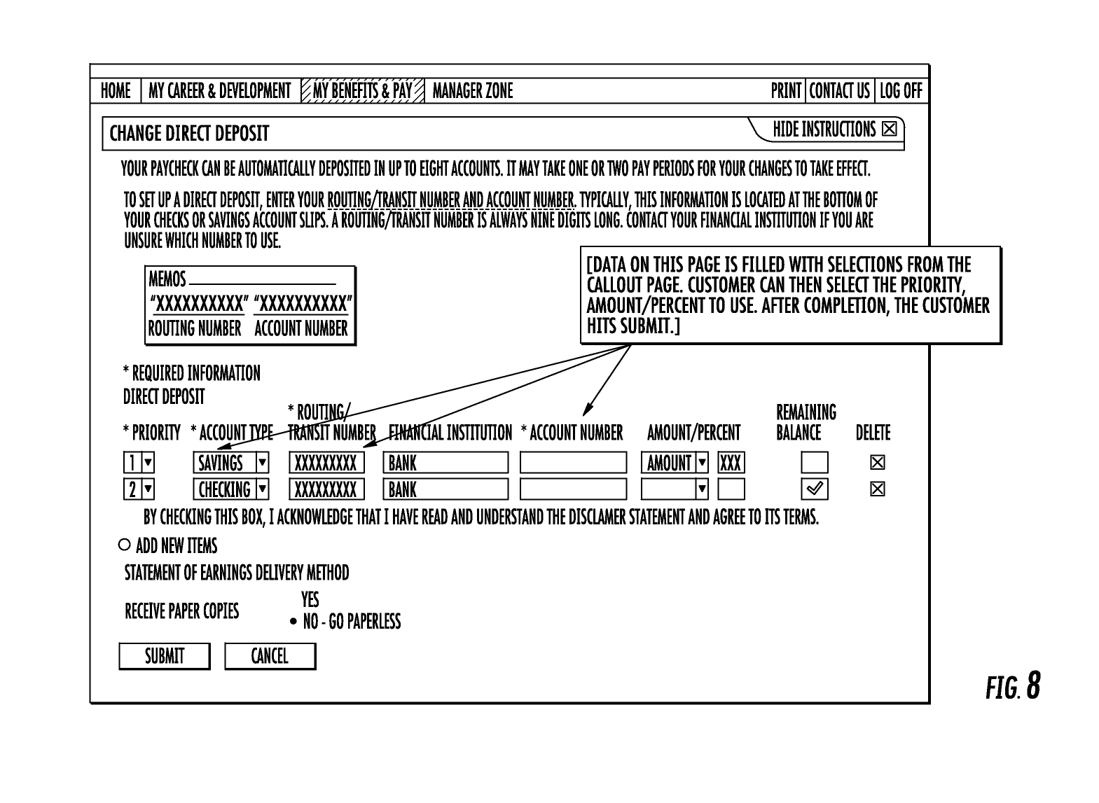

As shown in FIG. 8, the apparatus may automatically prefill the direct deposit summary with the confirmed account information. Thus, the present invention may enable the user to quickly and easily enroll in the direct deposit program without having to manually locate a routing/transit or account number associated with the user's banking account. This may not only save time for the user, it may also increase the number of users enrolled in the entity's direct deposit program.

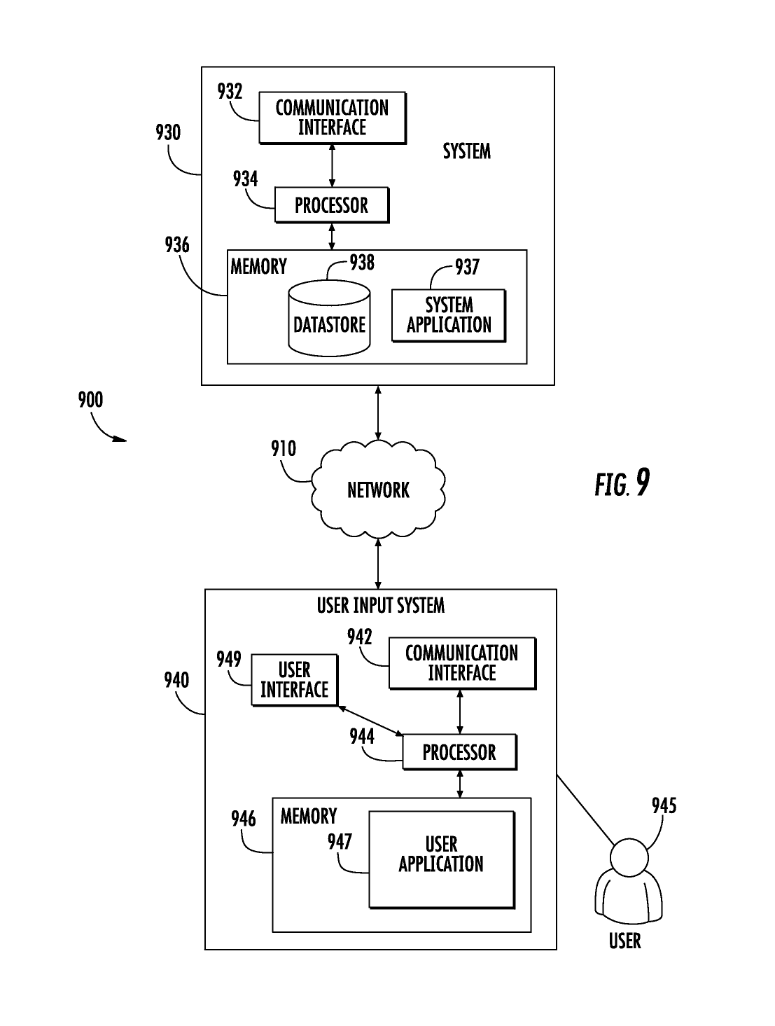

FIG. 9 presents an exemplary block diagram of the system environment 900 for implementing the process flow described in FIG. 1 in accordance with embodiments of the present invention. As illustrated, the system environment 900 includes a network 910, a system 930, and a user input system 940. Also shown in FIG. 9 is a user 945 of the user input system 940. The user input system 940 may be a mobile device described herein. The user 945 may be a person who uses the user input system 940 to execute a user application 947. The user application 947 may be an application to communicate with the system 930, perform a transaction, input information onto a user interface presented on the user input system 940, or the like. The user application 947 and/or the system application 937 may incorporate one or more parts of any process flow described herein.

As shown in FIG. 9, the system 930, and the user input system 940 are each operatively and selectively connected to the network 910, which may include one or more separate networks. In addition, the network 910 may include a telecommunication network, local area network (LAN), a wide area network (WAN), and/or a global area network (GAN), such as the Internet. It will also be understood that the network 910 may be secure and/or unsecure and may also include wireless and/or wireline and/or optical interconnection technology.

The user input system 940 may include any computerized apparatus that can be configured to perform any one or more of the functions of the user input system 940 described and/or contemplated herein. For example, the user 945 may use the user input system 940 to transmit and/or receive information or commands to and from the system 930. In some embodiments, for example, the user input system 940 may include a personal computer system (e.g. a non-mobile or non-portable computing system, a motor vehicle, or the like), a mobile computing device, a personal digital assistant, a mobile phone, a tablet computing device, a network device, and/or the like. As illustrated in FIG. 9, in accordance with some embodiments of the present invention, the user input system 940 includes a communication interface 942, a processor 944, a memory 946 having an user application 947 stored therein, and a user interface 949. In such embodiments, the communication interface 942 is operatively and selectively connected to the processor 944, which is operatively and selectively connected to the user interface 949 and the memory 946. In some embodiments, the user 945 may use the user application 947 to execute processes described with respect to the process flows described herein. Specifically, the user application 947 executes the process flow described in FIG. 1.

Each communication interface described herein, including the communication interface 942, generally includes hardware, and, in some instances, software, that enables the user input system 940, to transport, send, receive, and/or otherwise communicate information to and/or from the communication interface of one or more other systems on the network 910. For example, the communication interface 942 of the user input system 940 may include a wireless transceiver, modem, server, electrical connection, and/or other electronic device that operatively connects the user input system 940 to another system such as the system 930. The wireless transceiver may include a radio circuit to enable wireless transmission and reception of information. Additionally, the user input system 940 may include a positioning system. The positioning system (e.g. a global positioning system (GPS), a network address (IP address) positioning system, a positioning system based on the nearest cell tower location, or the like) may enable at least one of the user input system 940 or an external server or computing device in communication with the user input system 940 to determine the location (e.g. location coordinates) of the user input system 940.

Each processor described herein, including the processor 944, generally includes circuitry for implementing the audio, visual, and/or logic functions of the user input system 940. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 947 of the memory 946 of the user input system 940.

Each memory device described herein, including the memory 946 for storing the user application 947 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 9, the memory 946 includes the user application 947. The user application 947 may be associated with various features of the device identification program. In some embodiments, the user application 947 includes an interface for communicating with, navigating, controlling, configuring, and/or using the user input system 940. In some embodiments, the user application 947 includes computer-executable program code portions for instructing the processor 944 to perform one or more of the functions of the user application 947 described and/or contemplated herein. In some embodiments, the user application 947 may include and/or use one or more network and/or system communication protocols.

Also shown in FIG. 9 is the user interface 949. In some embodiments, the user interface 949 includes one or more output devices, such as a display and/or speaker, for presenting information to the user 945. In some embodiments, the user interface 949 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 945. In some embodiments, the user interface 949 includes the input and display devices of a mobile device, which are operable to receive and display information.

FIG. 9 also illustrates a system 930, in accordance with an embodiment of the present invention. The system 930 may refer to the “apparatus” described herein. The system 930 may include any computerized apparatus that can be configured to perform any one or more of the functions of the system 930 described and/or contemplated herein. In accordance with some embodiments, for example, the system 930 may include a computer network, an engine, a platform, a server, a database system, a front end system, a back end system, a personal computer system, and/or the like. Therefore, the system 930 may be a server managed by the entity. The system 930 may be located at the facility associated with the entity or remotely from the facility associated with the entity. In some embodiments, such as the one illustrated in FIG. 9, the system 930 includes a communication interface 932, a processor 934, and a memory 936, which includes a system application 937 and a datastore 938 stored therein. As shown, the communication interface 932 is operatively and selectively connected to the processor 934, which is operatively and selectively connected to the memory 936.

It will be understood that the system application 937 may be configured to implement any one or more portions of the various user interfaces and/or process flow described herein. The system application 937 may interact with the user application 947. It will also be understood that, in some embodiments, the memory includes other applications. It will also be understood that, in some embodiments, the system application 937 is configured to communicate with the datastore 938, the user input system 940, or the like.

It will be further understood that, in some embodiments, the system application 337 includes computer-executable program code portions for instructing the processor 934 to perform any one or more of the functions of the system application 937 described and/or contemplated herein. In some embodiments, the system application 937 may include and/or use one or more network and/or system communication protocols.

In addition to the system application 937, the memory 936 also includes the datastore 938. As used herein, the datastore 938 may be one or more distinct and/or remote datastores. In some embodiments, the datastore 938 is not located within the system and is instead located remotely from the system. In some embodiments, the datastore 938 stores information or data described herein. For example, the datastore 938 may store information associated with the user's account.

It will be understood that the datastore 938 may include any one or more storage devices, including, but not limited to, datastores, databases, and/or any of the other storage devices typically associated with a computer system. It will also be understood that the datastore 938 may store information in any known way, such as, for example, by using one or more computer codes and/or languages, alphanumeric character strings, data sets, figures, tables, charts, links, documents, and/or the like. Further, in some embodiments, the datastore 938 may include information associated with one or more applications, such as, for example, the system application 937. It will also be understood that, in some embodiments, the datastore 938 provides a substantially real-time representation of the information stored therein, so that, for example, when the processor 934 accesses the datastore 938, the information stored therein is current or substantially current.

It will be understood that the embodiment of the system environment illustrated in FIG. 9 is exemplary and that other embodiments may vary. As another example, in some embodiments, the system 930 includes more, less, or different components. As another example, in some embodiments, some or all of the portions of the system environment 900 may be combined into a single portion. Likewise, in some embodiments, some or all of the portions of the system 930 may be separated into two or more distinct portions.

In addition, the various portions of the system environment 900 may be maintained for and/or by the same or separate parties. It will also be understood that the system 930 may include and/or implement any embodiment of the present invention described and/or contemplated herein. For example, in some embodiments, the system 930 is configured to implement any one or more of the embodiments of the process flows described and/or contemplated herein in connection any process flow described herein. Additionally, the system 930 or the user input system 940 is configured to initiate presentation of any of the user interfaces described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for enrolling in a direct deposit program, the apparatus comprising:
a memory;
a processor; and
a module stored in memory, executable by the processor, and configured to:
initiate the presentation of a first interface prompting a user to enter user credentials associated with the user's financial institution account for registration of the user's payroll information;
retrieve information associated with the user's financial institution account based on a successful verification of the user credentials, wherein the information includes an account number and a transit routing number;
initiate the presentation of a second interface, wherein the second interface is populated with the retrieved information; and
complete the registration of the user's payroll information based on user confirmation of the retrieved information.

2. The apparatus of claim 1, wherein the user credentials comprise at least one of a username, a password, a passcode, or an answer to a security question.

3. The apparatus of claim 1, wherein the verification of the user credentials includes matching the user credentials entered by the user with user credentials stored in a database.

4. The apparatus of claim 1, wherein the user's financial account comprises a checking account, a savings account, or an investment account.

5. The apparatus of claim 1, wherein the second interface prompts the user to select at least one financial institution account.

6. The apparatus of claim 1, wherein the second interface prompts the user to select at least two financial institution accounts, wherein the two financial institution accounts are associated with different financial institutions.

7. The apparatus of claim 1, wherein the second interface prompts the user to select at least two financial institution accounts, wherein the two financial institution accounts are associated with the same financial institution.

8. The apparatus of claim 1, wherein the retrieved information is associated with the user selection of at least one financial institution account.

9. The apparatus of claim 1, wherein the user's selection of the financial institution account is modifiable.

10. The apparatus of claim 1, wherein the retrieved information is used to set up a direct deposit.

11. The apparatus of claim 1, wherein the user selection of a first account is associated with a first direct deposit percentage amount and the user selection of a second account is associated with a second direct deposit percentage amount.

12. The apparatus of claim 11, wherein the first account and the second account are sequentially sorted based on at least the first direct deposit percentage amount and the second direct deposit percentage amount.

13. The apparatus of claim 1, wherein the user selection of a first account is associated with a first direct deposit amount and the user selection of a second account is associated with a second direct deposit amount.

14. The apparatus of claim 13, wherein the user selection the first account and second account are sequentially sorted based on at least the first direct deposit amount and the second direct deposit amount.

15. The apparatus of claim 1, wherein the second interface displays a remaining balance associated with the direct deposit amount.

16. The apparatus of claim 1, wherein populating the retrieved information includes initiating a presentation of a third interface to the user to receive user confirmation of the retrieved information.

17. The apparatus of claim 1, wherein the second interface displays a summary of the retrieved information.

18. The apparatus of claim 1, wherein the population of the retrieved information occurs substantially simultaneously to successfully verifying the user credentials.

19. A method for enrolling in a direct deposit program, the method comprising:
initiating the presentation of a first interface prompting the user to enter user credentials associated with the user's financial institution account for registration of the user's payroll information;
retrieving information associated with the user's financial institution account based on a successful verification of the user credentials, wherein the information includes an account number and a transit routing number;
initiating the presentation of a second interface, wherein the second interface is populated with the retrieved information; and
completing the registration of the user's payroll information based on user confirmation of the retrieved information.

20. A computer program product for enrolling in a direct deposit program, the computer program product comprising a non-transitory computer-readable medium comprising code causing a computer to:
initiate the presentation of a first interface prompting a user to enter user credentials associated with the user's financial institution account for registration of the user's payroll information;
retrieve information associated with the user's financial institution account based on a successful verification of the user credentials, wherein the information includes an account number and a transit routing number;
initiate the presentation of a second interface, wherein the second interface is populated with the retrieved information; and
complete the registration of the user's payroll information based on user confirmation of the retrieved information.
